(19) United States
(12) Patent Application Publication
(10) Pub. No.: US 2008/0086460 A1
(43) Pub. Date: Apr. 10, 2008

(54) Local Search Directory Techniques

(76) Inventor: Kelsey Byron Stewart, Fishers, IN (US)

Correspondence Address: GOSNELL & ASSOCIATES, inc.;c/o Intellevate, P.O BOX 52050, MINNEAPOLIS, MN, 55402, US

(21) Appl. No.: 11/865,043

(22) Filed: Sep. 30, 2007

Related U.S. Application Data
(60) Provisional application No. 60/828,207, filed on Oct. 4, 2006.

(51) Int. Cl. G06F 17/30

(52) U.S. Cl. 707/3; 707/E17.108

(57) ABSTRACT

Various technologies and techniques are disclosed for providing and/or facilitating local searching. Basic information is imported from an external data provider about the businesses that are located in a particular locality. A customization feature allows each business to optionally add additional details to a respective business profile associated with the basic information. A categorized grouping of the businesses is created based at least in part upon the basic information. A web site is provided that allows an end user to access a local search directory containing at least the basic information about the businesses. Businesses are included in the directory without having to register. Search engines can use the categorized business directory to retrieve business information limited to a particular locality. A list of matching information is provided to the search engine for use by the search engine in responding to a user request.

### CROSS REFERENCE TO RELATED APPLICATIONS

This application claims the benefit of U.S. Provisional Application No. 60/828,207, filed Oct. 4, 2006, the specification of which is incorporated by reference herein in its entirety.

### BACKGROUND

With the Internet, businesses can advertise their goods and services in more places than ever before. The problem that businesses now face is where to advertise, since there are so many choices. Furthermore, when a business lists its contact information and business details with a particular search engine or yellow page directory, that information is only provided to the particular company providing that service. An extensive amount of money and effort is typically required to be expended by a particular business in order to allow the business to be found online by the majority of consumers who are actually looking for the good or service being offered by that business. The reason such effort and money is required is because the business must choose to pay several of the most popular web sites, search engines, and directories for advertising, or risk never being found.

The online advertising problems are compounded by the fact that the business must then enter the same information multiple times with each advertising service. Some small businesses do not even have a web presence to begin with, so the task of having to take an affirmative action to register with just one service can be prohibitive.

Furthermore, a problem with the search engines of today is that they search the vast Internet of web pages for relevant information. That is great when you are researching something for the entire world. But when you just want to know what stores down the street carry red couches, such a search provides little value. Thus, even if a business pays to advertise on a search engine, they are still not getting the local exposure that they might desire.

### SUMMARY

Various technologies and techniques are disclosed for providing and/or facilitating local searching. Basic information is imported from an external data provider about the businesses that are located in a particular locality. A customization feature allows each business to optionally add additional details to a respective business profile associated with the basic information. A categorized grouping of the businesses is created based at least in part upon the basic information. A web site is provided that allows an end user to access a local search directory containing at least the basic information about the businesses. Basic information about businesses is included in the directory without having to register. Search engines can use the categorized business directory to retrieve business information limited to a particular locality. A list of matching information is provided to the search engine for use by the search engine in responding to a user request.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a local search directory application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in providing an expanded service that a business can register for or subscribe to.

FIG. 5 is a process flow diagram for one implementation of the system of FIG. 1 illustrating the stages involved in providing search engines with access to the categorized business listings to facilitate searches.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that provides local search directories, but the system also serves other purposes in addition to these. In one implementation, one or more of the techniques described herein can be implemented as features within a web site, or from any other type of program or service that can be accessed by the general public.

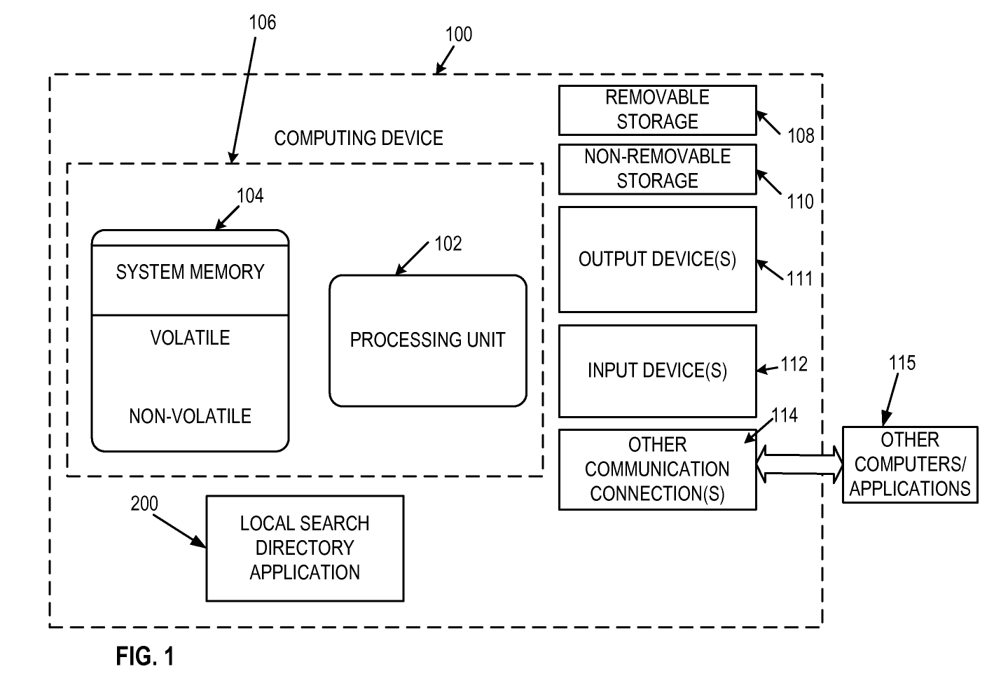

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here.

Local search directory application 200 includes program logic 204, which is responsible for carrying out some or all of the techniques described herein. Program logic 204 includes logic for importing basic information from an external data provider about a plurality of businesses that are located in a particular locality 206; logic for creating a categorized grouping of businesses based at least in part upon the basic information 208; logic for providing a web site that allows an end user to access a local search directory through the categorized grouping to view the basic information about a selected one or more of the plurality of businesses 210; logic for automatically registering the particular business in the local directory without requiring the particular business to take any action to be added to the directory 212; logic for providing a customization feature that allows the business to optionally add additional details (coupons, promotions, event information, classes, contact info, etc.) about the particular business to their respective business profile associated with the basic information (e.g. for a fee or for free) and for making the optionally added business details available on the web site 214; logic for providing the basic information to a plurality of external sources (e.g. yellow page directories, shopping directories, city and statewide portals, search engines, national databases, etc.) 216; logic for receiving a request from a search engine for business information limited geographically to a particular locality (or subset), accessing the categorized grouping to generate a match to the search engine request, and providing the list of information to the search engine for use by the search engine in responding to a user request 218; and other logic for operating the application 220. In one implementation, program logic 204 is operable to be called programmatically from another program, such as using a single call to a procedure in program logic 204.

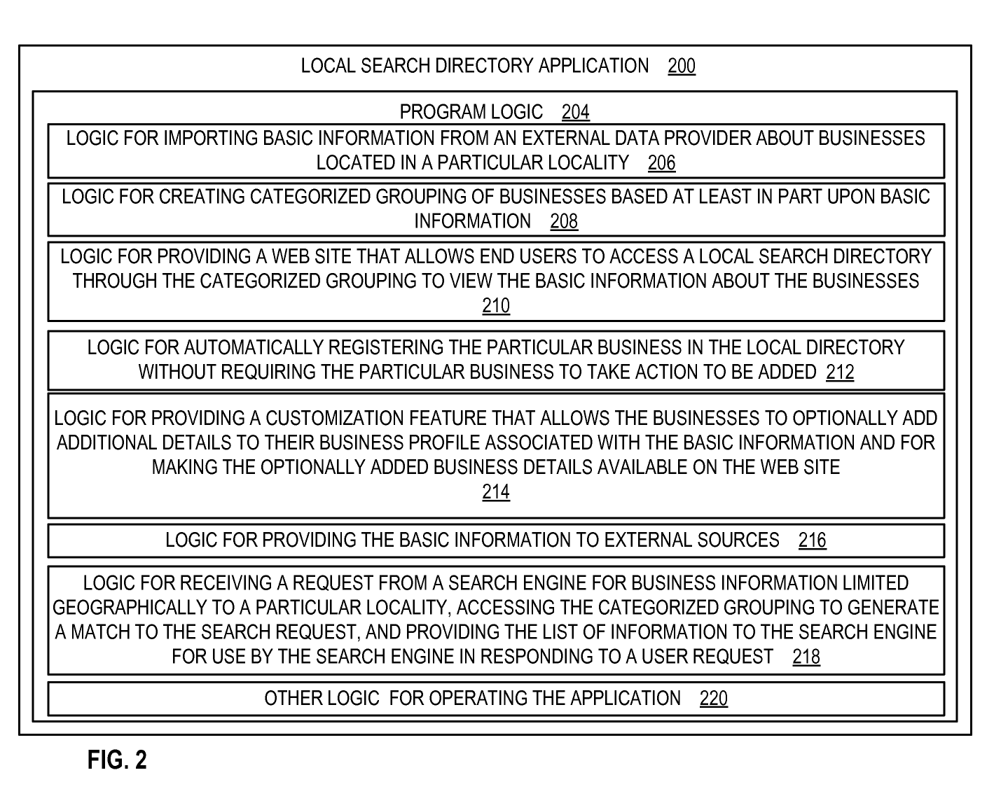

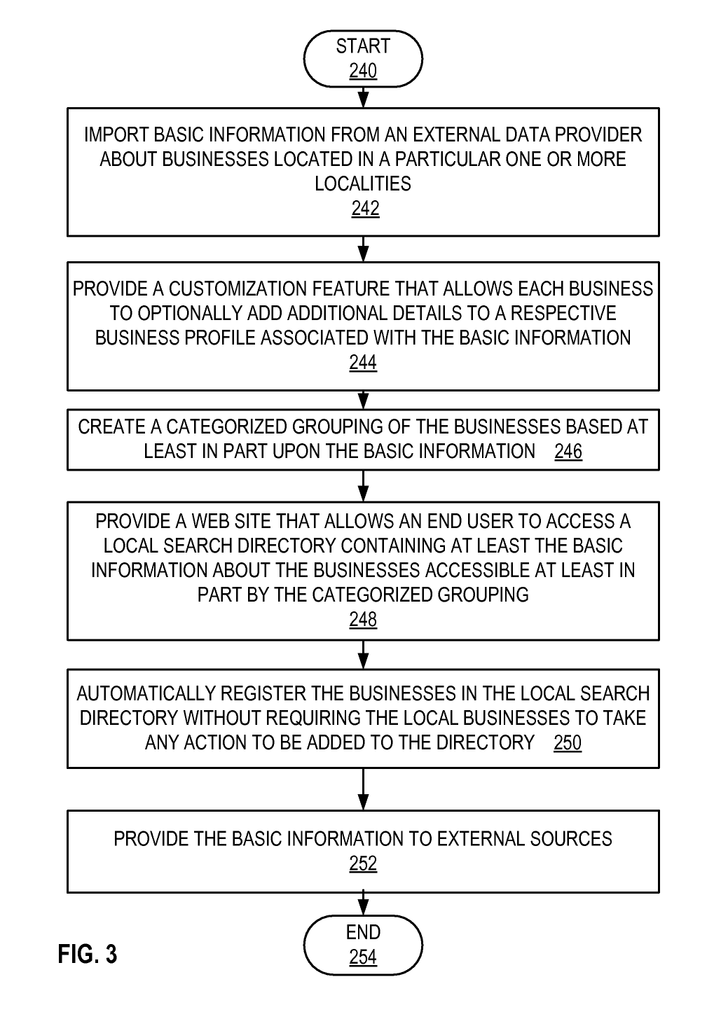

Turning now to FIGS. 3-5 with continued reference to FIGS. 1-2, the stages for implementing one or more implementations of local search directory application 200 are described in further detail. FIG. 3 is a high level process flow diagram for local search directory application 200. In one form, the process of FIG. 3 is at least partially implemented in the operating logic of computing device 100. The procedure begins at start point 240 with importing basic information from an external data provider about businesses located in a particular one or more localities (stage 242). A few non-limiting examples of a data provider includes a data provider that sell business information, a government agency that tracks business information, etc. A few non-limiting examples of localities include one or more cities, states, regions, and/or any other geographical grouping of businesses, etc. A customization feature is provided that allows each business to optionally add additional details to a respective business profile associated with the basic information (e.g. upon registering for an expanded service) (stage 244). In one implementation, coupons, promotions, classes, hours, images, links to an external web site of the business, and/or various other details about the business can be provided with this expanded service. The additional details can be provided for a fee, for free, etc. A categorized grouping of the businesses is created based at least in part upon the basic information (stage 246). A web site is provided that allows an end user to access a local search directory containing at least the basic information (and/or the optionally added additional details in the respective business profile) about the businesses accessible at least in part by the categorized grouping (stage 248). In one implementation, the categories allow the user to quickly navigate through the businesses to find one of interest (stage 248). The businesses are automatically registered in the local search directory without requiring the respective local businesses to take any action to be added to the directory (stage 250). Alternatively or additionally, the basic information is provided to a plurality of external sources, such as in real-time, so the other external sources also have up-to-date information (stage 252). A few non-limiting examples of external sources include yellow page directories, shopping directories, search engines, city and statewide portals, and/or national databases, etc. (stage 252). The process ends at end point 254.

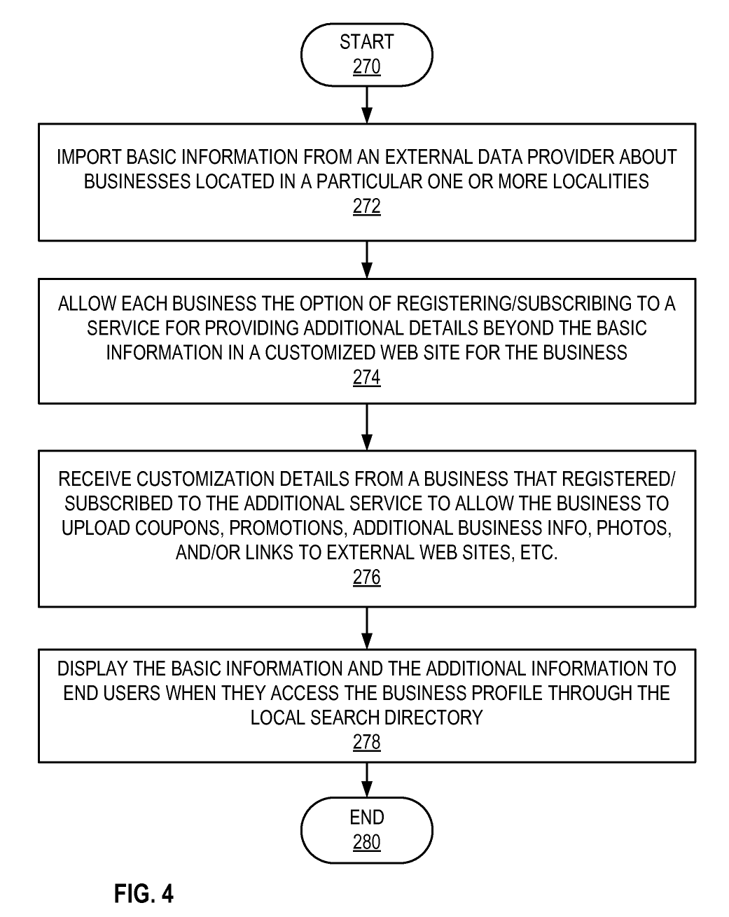

FIG. 4 illustrates one implementation of the stages involved in providing an expanded service that a business can register for or subscribe to. In one form, the process of FIG. 4 is at least partially implemented in the operating logic of computing device 100. The procedure begins at start point 270 with importing basic information from one or more external data providers about businesses located in a particular one or more localities (stage 272). Each business (or some subset of all of the businesses) has the option of registering/subscribing to a service for providing additional details (e.g. coupons, promotions, etc.) beyond the basic information in a customized web site for the business (stage 274). The customization details are received from a business that registered/subscribed to the additional service to allow the business to upload coupons, promotions, additional business info, photos, and/or links to external web sites [such as the main business web site], etc. (stage 276). Both the basic information and the additional information provided using the extended service are then displayed to end users when they access the particular business profile through the local search directory (stage 278). The process ends at end point 280.

In one implementation, users are able to access local search directory application 200 to perform a variety of searches for particular businesses of interest. The advanced categorization scheme makes various types of searches possible. For example, a user can search for all of the businesses having jobs currently open on 96^{th} street in Indianapolis. A user can search for all of the stores having red couches for sale in their sale directory. Numerous other combinations of searches are also possible based upon the categories in which a particular business is listed. In one implementation, the categories are chosen automatically based on the basic business information that is imported from the external data provider. Alternatively or additionally, with the expanded service, the respective business can further customize the types of categories and additional information available to make the searches more meaningful to a potential customer.

In one implementation, the local search directory application 200 is used by a business to wrap an existing web page with additional details to further expand and deliver that content. For example, an existing primary web site of that business can be wrapped and delivered from the search directory application 200 so that the content will be found in the categories, whereas the content would otherwise not be found easily if it existed on the business's primary web site alone.

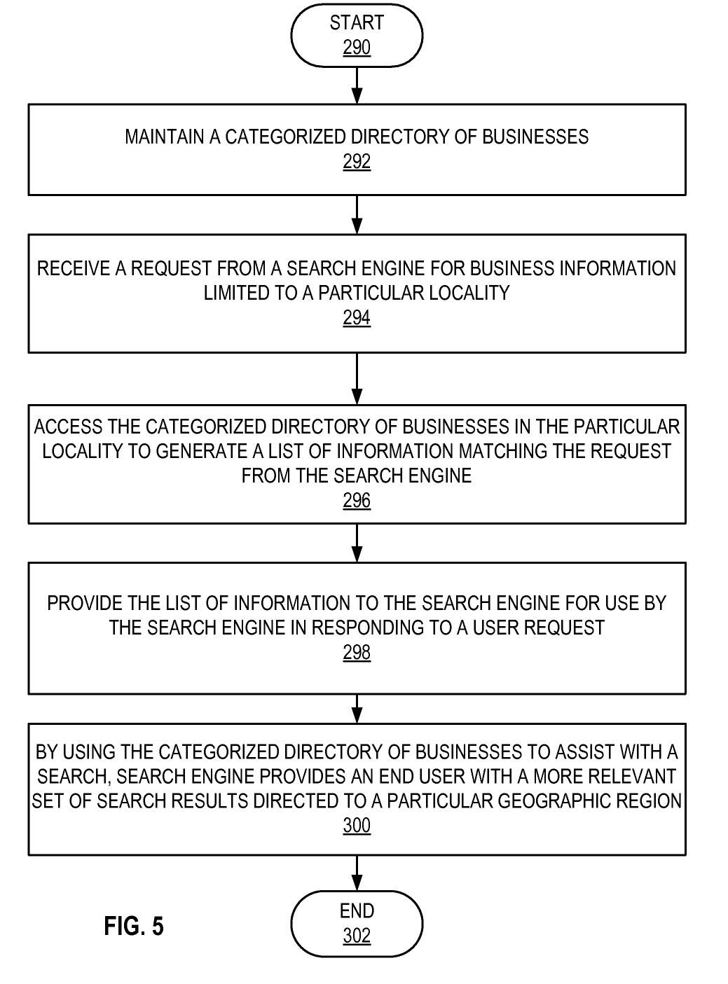

FIG. 5 illustrates one implementation of the stages involved in providing search engines with access to the categorized business listings to facilitate searches. In one form, the process of FIG. 5 is at least partially implemented in the operating logic of computing device 100. The procedure begins at start point 290 with maintaining a categorized directory of businesses (stage 292). A request is received from a search engine for business information limited to a particular locality (stage 294). The categorized directory of businesses is accessed in the particular locality to generate a list of information (e.g. a list of business identifiers) that matches the request from the search engine (stage 296). The resulting list of information is provided to the search engine for use by the search engine in responding to a user request (stage 298). In one implementation, the search engine uses the business identifiers to look up the desired level of details about the business (stage 298). By using the categorized directory of businesses to assist with a search, the search engine is able to provide an end user with a more relevant set of search results that are directed to a particular geographic region based on the particular locality (stage 300). The process ends at end point 302.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for providing local search directories comprising the steps of:
importing basic information from an external data provider about a plurality of businesses that are located in a particular locality;
providing a customization feature that allows each of the plurality of businesses to optionally add additional details to a respective business profile associated with the basic information;
creating a categorized grouping of the plurality of businesses based at least in part upon the basic information; and
providing a web site that allows an end user to access a local search directory containing at least the basic information about the plurality of businesses accessible at least in part by the categorized grouping.

2. The method of claim 1, wherein a particular business in the locality is automatically registered in the local search directory without having to take any action to be added to the directory.

3. The method of claim 1, further comprising:
providing the basic information to a plurality of external sources, the external sources being selected from the group consisting of yellow page directories, shopping directories, search engines, and national databases.

4. The method of claim 1, wherein any of the optionally added additional details are also provided in the web site.

5. The method of claim 1, wherein the locality is a particular state.

6. The method of claim 1, wherein the locality is a particular city.

7. The method of claim 1, wherein the locality includes a plurality of states.

8. The method of claim 1, wherein the external data provider is a data provider company that is in the business of gathering and reselling business information.

9. The method of claim 1, wherein the external data provider is a government agency that handles business records.

10. A computer-readable medium having computer-executable instructions for causing a computer to perform the steps recited in claim 1.

11. A computer-readable medium having computer-executable instructions for causing a computer to perform steps comprising:
import basic information from an external data provider about a plurality of businesses that are located in a particular locality;
create a categorized grouping of the plurality of businesses based at least in part upon the basic information;
provide a web site that allows an end user to access a local search directory through the categorized grouping to view the basic information about a selected one or more of the plurality of businesses; and
wherein a particular business in the locality is automatically registered in the local search directory without having to take any action to be added to the directory.

12. The computer-readable medium of claim 11, having computer-executable instructions further operable to perform the step comprising:
provide a customization feature that allows each of the plurality of businesses to optionally add additional details to a respective business profile associated with the basic information.

13. The computer-readable medium of claim 12, having computer-executable instructions further operable to perform the step comprising:
make the optionally added additional details available on the web site.

14. The computer-readable medium of claim 11, having computer-executable instructions further operable to perform the step comprising:
providing the basic information to a plurality of external sources, the external sources being selected from the group consisting of yellow page directories, shopping directories, search engines, and national databases.

15. The computer-readable medium of claim 11, having computer-executable instructions further operable to perform the steps comprising:
receive a request from a search engine for business information limited geographically to at least a part of the particular locality;
accessing the categorized grouping of businesses in the particular locality to generate a list of information matching the request from the search engine; and
providing the list of information to the search engine for use by the search engine in responding to a user request.

16. A method for providing business information to search engines comprising the steps of:
maintaining a categorized directory of businesses;
receiving a request from a search engine for business information limited to a particular locality;
accessing the categorized directory of businesses in the particular locality to generate a list of information matching the request from the search engine; and
providing the list of information to the search engine for use by the search engine in responding to a user request.

17. The method of claim 16, wherein the list of information provided to the search engine includes a plurality of identifiers for the businesses that matched the request.

18. The method of claim 17, wherein the plurality of identifiers can be used by the search engine to look up a plurality of additional details about the businesses from the categorized directory of businesses.

19. The method of claim 16, wherein by using the categorized directory of businesses to assist with a search, the search engine is able to provide an end user with a more relevant set of search results that are directed to a particular geographic region based on the particular locality.

20. A computer-readable medium having computer-executable instructions for causing a computer to perform the steps recited in claim 16.
